(19) United States
(12) Patent Application Publication
(10) Pub. No.: US 2002/0085698 A1
(43) Pub. Date: Jul. 4, 2002

(54) Communication device with privacy mode

(75) Inventor: Frank Liebenow, Dakota Dunes, SD (US)

Correspondence Address: GATEWAY, INC., ATTN: MARK S. WALKER, 610 GATEWAY DRIVE, MAIL DROP Y-04, N. SIOUX CITY, SD, 57049, US

(73) Assignee: Gateway, Inc.

(21) Appl. No.: 09/752,037

(22) Filed: Dec. 29, 2000

(51) Int. Cl. H04M 3/42; H04M 1/64

(52) U.S. Cl. 379/207.13; 379/211.02; 379/88.25

(57) ABSTRACT

A communication device (such as a cellular telephone, personal digital assistant, portable computer, or other similar device) is provided with a special privacy mode for use when a user desires privacy. Upon receiving a call from a caller, the communication device immediately provides to the caller a greeting, indicating that a user of the communication device desires privacy. However, if the caller needs to immediately contact the user, the caller enters a privacy mode code to override the privacy mode, and the call is then completed and the user is signaled (e.g., the communication device rings or vibrates). Otherwise, if the caller enters no privacy mode code, the call is then routed to a message system and the caller is allowed to leave a message for the user.

### FIELD OF THE INVENTION

The present invention relates to communication devices, and in particular, to a communication device that has a special mode for use when a user desires privacy.

### BACKGROUND OF THE INVENTION

Communication devices, such as cellular telephones, provide users the ability to receive telephone calls wherever they may be. Many times, users are temporarily unavailable, such as in a meeting, out for dinner, or at a movie. Other times, a user desires privacy for relaxation, or when working on a project that requires uninterrupted concentration. A signaling telephone, such as a ringing telephone, can be a disturbance in these situations. Even if the user utilizes a vibrate mode, the signaling of the telephone still distracts the user.

Currently, users will shut off their cellular telephone when they desire privacy. Some telephones provide modes that direct calls to an answering or messaging system without signaling or with a single, short ring. Such modes may provide a message to the caller that the user is in a meeting or otherwise desires privacy. Call screening and blocking modes provide a message indicating that the user is not accepting calls of a certain nature based on caller ID information. Such modes may also route selected calls to another telephone number.

There is a need for a method of informing a caller that a user currently desires privacy, but also for enabling the caller to directly contact the user in spite of such desire for privacy.

### SUMMARY OF THE INVENTION

Embodiments of the present invention relate to a communication device (such as a cellular telephone, personal digital assistant, portable computer, or other similar device) that has a special privacy mode for use when a user desires privacy. Upon receiving a call from a caller, the communication device immediately provides to the caller a greeting, indicating that the user of the communication device desires privacy. However, if the caller needs to immediately contact the user, the caller enters an interrupt or privacy mode code to override the privacy mode, and the call is then completed and the user is signaled (e.g., the communication device rings or vibrates). Otherwise, if the caller enters no privacy mode code, the call is then routed to a message system and the caller is allowed to leave a message for the user.

### BRIEF DESCRIPTION OF THE DRAWINGS

FIG. 1 is a block diagram of components of a communication device which provides a privacy mode in accordance with a preferred embodiment of the present invention.

FIG. 2 is a flowchart showing steps for initiating a privacy mode for the communication device shown in FIG. 1.

FIG. 3 is a flowchart showing a method for handling a call to the communication device illustrated in FIG. 1, wherein the privacy mode is enabled.

### DETAILED DESCRIPTION OF THE INVENTION

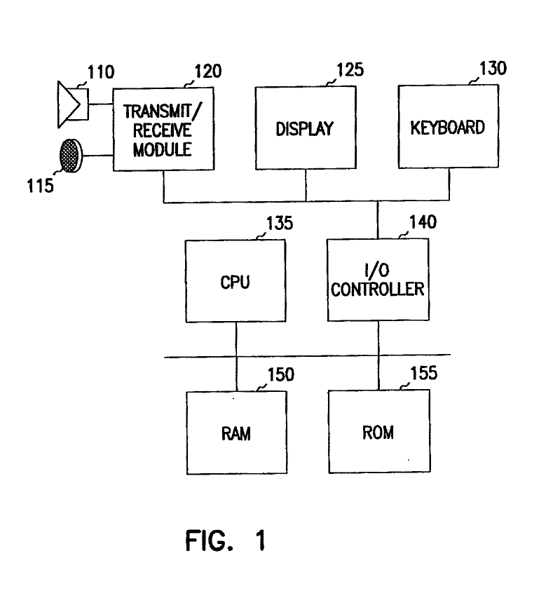

FIG. 1 is a block diagram illustrating the components of a communication device, such as a cellular telephone, which provides a privacy mode in accordance with a preferred embodiment of the present invention. The communication device comprises an audio speaker 110 and a microphone 115 coupled to a transmit/receive module 120. The transmit/receive module 120 is in turn coupled to a display device 125 and a keyboard 130. The display device 125 shows information, including but not limited to, caller ID information and other information as desired (such as email and schedule information), to a user of the communication device. The keyboard 130 is used to enter codes into the communication device for placing the communication device into the privacy mode. The keyboard 130 preferably comprises a standard telephone keypad, but alternatively, may also comprise other desired keys, such as a dedicated key for placing the communication device into the privacy mode. Further, the keyboard 130 may comprise other input devices, such as a standard alphanumeric keyboard, a mouse, pen, or other pointing device used in conjunction with the display device 125, or the like. Alternatively, in lieu of a keyboard and/or pointing device, the communication device may use speech recognition to capture input commands and speech generation to output prompts and status messages.

The keyboard 130, display device 125 and transmit/receive module 120 are coupled to an input/output (I/O) controller 140, which in turn is coupled to a central processing unit CPU 135, RAM 150 and ROM 155. RAM 150 and ROM 155 are computer readable memory for storing (either temporarily and/or permanently) program instructions executed by the CPU 135. I/O controller 140 routes information among the various components in the communication device.

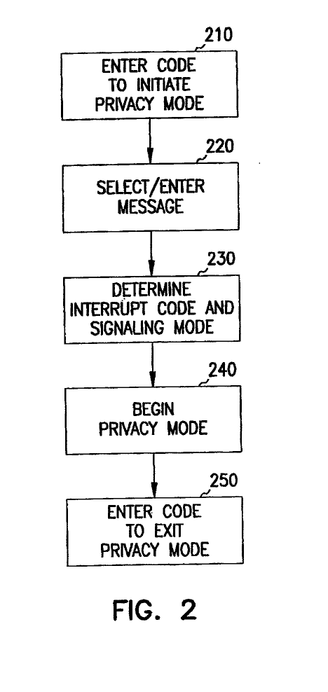

A method for placing the communication device into the privacy mode is shown in FIG. 2. At step 210, the communication device is placed into the privacy mode by use of the keyboard 130. In preferred embodiments, a special code is entered using the keys on the standard telephone keypad. In alternative embodiments, a dedicated key may be provided to place the communication device into the privacy mode. In further alternative embodiments, other input devices, such as a mouse, pen or other pointing device, may be utilized to place the communication device into the privacy mode. In still further alternative embodiments, voice commands or instructions for placing the communication device into the privacy mode may be received via the microphone 115. Speech recognition may be performed using the CPU 135 and the program instructions stored in the RAM 150 and/or the ROM 155. Digitization of the voice may be performed by a special module integrated into the microphone 115 or other components of the communication device. The digitized speech may then be recognized as a command or instruction to place the communication device into the privacy mode.

In preferred embodiments, at step 220, the user selects a special greeting or message for playing to a caller. In one embodiment, the user enters one or more keystrokes to record such a message, and enters other keystrokes to select a pre-recorded message. For example, the message may state, “I am currently in a meeting, and you will be sent to my voice mail system. If this is very important, please press ‘xyz’ to alert me to the call.” As another example, the message may indicate: “I do not wish to be disturbed.”

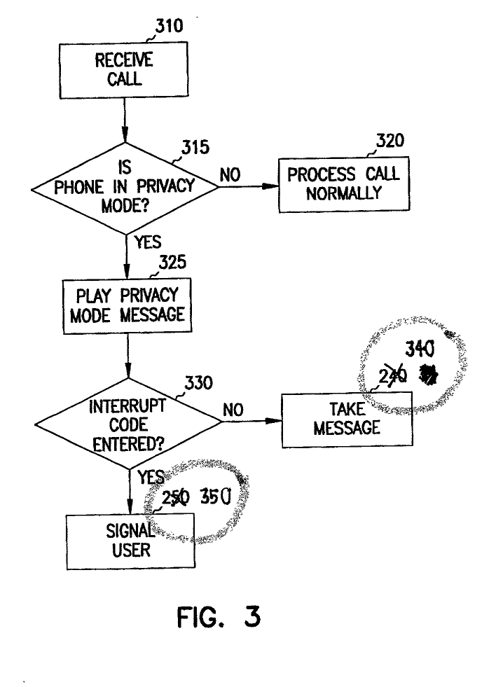

At step 230, the user is prompted to select an interrupt code. The interrupt code permits a caller to enter the code, and thus, to cause the communication device to signal the user regarding the call even if the communication device is in the privacy mode, as described further with respect to FIG. 3. The interrupt code may be a selected privacy override code or other predetermined code, or alternatively, may be selected by the user. Further, the interrupt code may be a single keystroke or a sequence of keystroke that are recognizable by the communication device as a special code to permit a call to be completed and to signal the user even if the communication device is in the privacy mode. By selecting an interrupt or override code that is a sequence of keystrokes, the user can selectively give out that code to certain individuals by whom the user may want to be interrupted, for instance, a family member.

Next, at step 240, the communication device enters the privacy mode, and the method described below with reference to FIG. 3 is then performed. At step 250, further keystrokes or other input are used to cause the communication device to exit the privacy mode in a similar manner as described above with respect to step 210.

FIG. 3 is a flowchart showing a method for handling a call to the communication device illustrated in FIG. 1, wherein the privacy mode is enabled. First, the call is received at step 310. At step 315, the communication device determines if the device is in the privacy mode. If the communication device is not in the privacy mode, the call is handled in a normal manner at step 320. However, if the communication device is in the privacy mode, the selected message or greeting is played to the caller at step 325. Further, there is no audible or other signaling of the user which may interrupt the privacy of the user. The display 125 may provide information to the user regarding the incoming call, but not in a manner to draw attention away from the reason the user desired privacy. The user may also select not to have the display 125 provide any information regarding the incoming call. This is useful where the communication device is a computer or other type of device on which the user may be performing work.

If no interrupt code is received (i.e., no interrupt code is entered into the communication device by the caller) at step 330, the call is routed to a message system and a message is taken at step 340. It should be noted that even if a message is being taken, the interrupt code can be received. Further, if desired, no message is played, or a busy signal is returned to the caller. If an interrupt code is received (i.e., the interrupt code is entered into the communication device by the caller) at step 330, the call is completed, and the user is signaled at step 350.

In another preferred embodiment of the present invention, a switch or base station provides the functionality described above. In other words, the steps for providing the communication device with the privacy mode feature are performed or executed at the switch or base station. Input by the user into the communication device is simply passed on to the switch or base station, which also comprises a CPU and memory devices, as well as standard features that interpret signals from the communication device. The switch or base station interprets such signals to both logically place the communication device into and out of the privacy mode as described above with respect to FIG. 2, and also handle calls to the communication device as described above with respect to FIG. 3. For example, when the user enters input into the communication device in order to place the communication device into the privacy mode, this input is transmitted to the switch or base station, including a request to place the communication device into the privacy mode, the desired greeting message or message choice, and the desired interrupt or override code. Any incoming call is handled by the switch or base station and is routed to the communication device only if the caller enters the interrupt or override code. When the user enters input into the communication device in order to place the communication device out of the privacy mode, this input is transmitted to the switch or base station, including a request to place the communication device out of the privacy mode. In this embodiment, no modification of the communication device is necessary, as the switch or base station simply responds to signals from the communication device and handles calls in accordance with such signals. Alternatively, the communication device may provide a special key for use in activating and deactivating the privacy mode.

A method and a system for handling a call to a communication device with a privacy mode have been disclosed. The privacy mode enables the user of the communication device to provide to callers an outgoing message, indicating that the user does not wish to be disturbed unless the call is an emergency. The communication device provides such message without signaling the user. In that event, an interrupt code may be provided in the message, or to select potential callers ahead of time. The interrupt code causes the communication device to signal the user, even though the communication device is in privacy mode. The privacy mode allows the user to keep the communication device ready for emergency calls without interrupting the user and others by signaling the user for every call.

In the embodiments described above, the communication device is a cellular telephone. However, the invention is applicable to different types of communication devices, such as personal digital appliances with communication capabilities. It is also applicable to normal telephones, such as when a user is participating in a conference call and does not desire the phone to signal that another call is being attempted unless the security code is entered by the caller.

While the above detailed description refers to exemplary embodiments of the present invention, it is to be understood that other embodiments may be utilized and that logical, mechanical, electrical and other changes may be made without departing from the spirit or scope of the present invention. This application is intended to cover any adaptations or variations of the present invention. The above detailed description is, therefore, not to be taken in a limiting sense, and the scope of the present invention is defined only by the appended claims and equivalents thereof.

What is claimed is:

1. A method of handling a call from a caller to a communication device, the method comprising:
receiving the call;
determining if the communication device is in a privacy mode; and
if the communication device is in the privacy mode, completing the call if a privacy mode code is entered by the caller.

2. The method of claim 1, further comprising if the communication device is in the privacy mode, routing the call to a message system if no privacy mode code is entered by the caller.

3. The method of claim 1, wherein the privacy mode code is selected by a user of the communication device.

4. The method of claim 1, wherein the communication device is one of: a cellular telephone and a personal digital assistant.

5. The method of claim 1, wherein the method is performed by one of: a base station and a switch.

6. The method of claim 5, further comprising the step of receiving a request from the communication device to place the communication device in the privacy mode.

7. The method of claim 6, wherein the request further comprises:
a privacy mode message selected by a user of the communication device and adapted to be provided to the caller prior to completing the call; and
the privacy mode code selected by the user of the communication device.

8. The method of claim 6, further comprising the step of receiving a request from the communication device to place the communication device out of the privacy mode.

9. A method of handling a call from a caller to a communication device, the method comprising:
receiving the call;
determining if the communication device is in a privacy mode; and
if the communication device is in the privacy mode, providing a privacy mode message including a selected privacy override code to the caller.

10. The method of claim 9, further comprising if the communication device is in the privacy mode, completing the call if the selected privacy override code is entered by the caller.

11. The method of claim 9, further comprising if the communication device is in the privacy mode, routing the call to a message system if no selected privacy override code is entered by the caller.

12. The method of claim 9, wherein the privacy mode message is selected from a group of prerecorded messages.

13. The method of claim 9, wherein the privacy mode message is recorded by a user of the communication device.

14. The method of claim 9, wherein the privacy override code is selected by a user of the communication device.

15. The method of claim 9, wherein the communication device is a cellular telephone or a personal digital assistant.

16. The method of claim 9, wherein the method is performed by a base station or a switch.

17. The method of claim 16, further comprising the step of receiving a request from the communication device to place the communication device in the privacy mode.

18. The method of claim 17, wherein the request further comprises:
the privacy mode message selected by a user of the communication device and adapted to be provided to the caller upon receiving the call; and
the privacy override code selected by the user of the communication device.

19. The method of claim 17, further comprising the step of receiving a request from the communication device to place the communication device out of the privacy mode.

20. A computer readable medium having instructions for causing a computer to perform a method of handling a call from a caller to a communication device, the method comprising:
receiving the call;
determining if the communication device is in a privacy mode; and
if the communication device is in the privacy mode, completing the call if a predetermined code is entered by the caller.

21. The computer readable medium of claim 20, further comprising if the communication device is in the privacy mode, routing the call to a message system if no predetermined code is entered by the caller.

22. A computer readable medium having instructions for causing a computer to perform a method of handling a call from a caller to a communication device, the method comprising:
receiving the call;
determining if the communication device is in a privacy mode; and
if the communication device is in the privacy mode, providing a privacy mode message including a selected privacy override code to the caller.

23. The computer readable medium of claim 22, further comprising if the communication device is in the privacy mode, completing the call if the privacy override code is entered by the caller.

24. The computer readable medium of claim 22, further comprising if the communication device is in the privacy mode, routing the call to a message system if no privacy override code is entered by the caller.

25. A system for handling a call from a caller to a user of a communication device, the system comprising:
a data entry device capable of receiving input to cause the communication device to enter a privacy mode;
a memory capable of storing a privacy mode message, the privacy mode message adapted to be provided to the caller prior to completing the call to the user; and
a receiver capable of completing the call to the user if a privacy mode code is entered by the caller.

26. The system of claim 25, further wherein the receiver is capable of routing the call to a message system if no privacy mode code is entered by the caller.

27. The system of claim 25, wherein the data entry device is a telephone keypad.

28. The system of claim 25, wherein the privacy mode code comprises at least one keystroke from the data entry device.

29. The system of claim 25, wherein the privacy mode code is selected by the user of the communication device.

30. The system of claim 25, wherein the communication device is one of: a cellular telephone and a personal digital assistant.

31. A system for handling a call from a caller to a user of a communication device, the system comprising:
a data entry device capable of receiving input to cause the communication device to enter a privacy mode; and
a memory capable of providing a privacy mode message including a selected privacy override code to the caller prior to completing the call to the user.

32. The system of claim 31, further comprising a receiver capable of completing the call to the user if the selected privacy override code is entered by the caller.

33. The system of claim 32, further wherein the receiver is capable of routing the call to a message system if no selected privacy override code is entered by the caller.

34. The system of claim 31, wherein the selected privacy override code is provided by the user of the communication device.

35. A system for handling a call from a caller to a user of a communication device, the system comprising:
a data entry device capable of receiving input to cause the communication device to enter a privacy mode; and
a receiver capable of receiving the call to the communication device and completing the call to the user only if an interrupt is received from the caller.

36. The system of claim 35, wherein the interrupt is a privacy mode code entered by the caller.

37. A system for handling a call from a caller to a user of a communication device, the system comprising:
a receiver capable of receiving the call and a privacy mode code entered by the caller;
a memory capable of storing a status indicating if the communication device is in a privacy mode; and
a transmitter capable of completing the call to the user if the communication device is in the privacy mode and the privacy mode code is entered by the caller.

38. The system of claim 37, wherein the memory is further capable of storing a message from the caller if the communication device is in the privacy mode and no privacy mode code is entered by the caller.

39. The system of claim 37, wherein the memory is further capable of storing a privacy mode message adapted to be provided to the caller prior to completing the call to the user.

40. The system of claim 37, wherein the receiver is further capable of receiving a request from the communication device to place the communication device in the privacy mode

41. The system of claim 40, wherein the request further comprises:
a privacy mode message selected by a user of the communication device and adapted to be provided to the caller prior to completing the call to the user; and
the privacy mode code selected by the user of the communication device.

42. The method of claim 40, wherein the receiver is further capable of receiving a request from the communication device to place the communication device out of the privacy mode.

43. The system of claim 37, wherein the communication device is one of: a cellular telephone and a personal digital assistant.
